(19) United States
(12) Patent Application Publication
(10) Pub. No.: US 2009/0004434 A1
(43) Pub. Date: Jan. 1, 2009

(54) NON-SCRATCH ENAMELLED COOKING UTENSIL AND METHOD TO MANUFACTURE SUCH A UTENSIL

(76) Inventors: Fabrice Parent, Mery (FR); Pierre-Jean Muller, Saint Felix (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/163,289

(22) Filed: Jun. 27, 2008

(30) Foreign Application Priority Data
Jun. 29, 2007 (FR) 07 04731

(51) Int. Cl. B32B 3/30; B05D 5/00

(52) U.S. Cl. 428/148; 428/143; 427/258

(57) ABSTRACT

A non-scratch enameled cooking utensil and method of manufacturing the cooking utensil. The cooking utensil can comprise a base with an inner face adapted to receive food and an outer face adapted to be positioned proximate a heat source. The outer face is coated with an enamel coating which comprises rounded fillers. Some of the rounded fillers protrude from the enamel coating such that said protrusion is visible from an outer surface of the enamel coating. At least some of the rounded fillers are formed from a material having a melting point greater than 900° C. and MOHS hardness less than 6. The protruding rounded fillers are distributed homogeneously on the outer surface of the enamel coating.

### RELATED APPLICATION

The present application claims priority to French Application No. 07 04731 filed Jun. 29, 2007, which is incorporated herein in its entirety by reference.

### TECHNICAL FIELD

The present invention relates in general to an enameled cooking utensil compatible with use on a vitroceramic or induction bob plate, and a method to manufacture such a utensil.

### BACKGROUND ART

Cooking utensils typically comprise a hollow bowl, wherein the base has an inner face intended to receive foods and an outer face on the side of the heat source. The outer face may be typically coated with one or more enamel layers, which make it possibly not only to improve the appearance of the base of the utensil, but also to protect it, particularly against thermal or oxidation shocks (for example in the case of cast iron cooking utensils).

French Patent FR 2,576,038, belonging to the applicant, describes a coating formed of two enamel layers containing glass beads, at least some of which have a diameter greater than the thickness of the enamel layer containing said beads and protrude from the surface of said layers. However, the glass beads of the second layer are arranged in a staggered fashion with respect to the glass beads of the first layer and tend to become embedded between the glass beads of the first layer and therefore not protrude from the second outer layer. Therefore, the resistance of the coating to wear is diminished. Moreover, the enamel coating, due to its insulating properties, affects the heat transmission via the base of the cooking utensil.

Therefore, in order to remedy these bead subsidence problems and thus increase the resistance of the coating to wear, the applicant proposed in a European Patent EP 0 323 349 a cooking utensil comprising a base having on the outer face thereof an enamel coating. This enamel coating comprises a first enamel layer covering the outer face of the base of the utensil, followed by two stacked enamel layers each containing glass beads, the second enamel layer being a discontinuous outer layer, which forms a raised relief decor. Some of the glass beads present in these layers have a diameter greater than the thickness of the enamel layers containing the beads and protrude from the surface of the layers. In addition, some of the beads of the discontinuous outer layer rest on the beads of the underlying layer.

However, such a coating involves the drawback that the glass against glass type contact between the glass beads protruding from the decorative enamel layer and, for example, a vitroceramic type hob are liable to create scratches in the hob.

### SUMMARY OF THE INVENTION

The applicant has now discovered that it was possible to solve these scratching problems are solved by replacing the glass beads by rounded fillers (or beads) made of a material having a hardness less than that of glass and a sufficiently high melting point so that the beads do not melt during the firing step of the utensil preparation method.

More specially, the applicant discovered that an enamel coating containing rounded fillers has an improved non-scratch effect if the fillers are made of a material having a melting point greater than 900° C. and a hardness on the MOHS scale less than 6, and that those protruding from the surface of the enamel coating are distributed homogeneously on the surface of the coating.

The term “MOHS” hardness refers to the ability of the substrate to be scratched by a mineral defined by the table below:

| MOHS hardness | Name of minerals |
|---|---|
| 1 | Talc |
| 2 | Gypsum |
| 3 | Calcite |
| 4 | Fluorite |
| 5 | Apatite |
| 6 | Orthoclase |
| 7 | Quartz |
| 8 | Topaz |
| 9 | Corundum |
| 10 | Diamond |

The term “rounded fillers” refers to fillers free from angles, particularly ovoid or spherical in shape.

The applicant also discovered that it was possible to produce such a coating by means of serigraphic application, followed by drying and firing of at least one thixotropic rheofluidifying enamel paste comprising the rounded spherical fillers (or beads).

The term “enamel paste” refers to an anhydrous enamel frit powder-based paste.

The term “thixotropic rheofluidifying paste” refers to a paste being at rest in the viscous state or in gel form and becoming liquid during the serigraphic application thereof on a substrate or under mechanical stirring, the decrease in the viscosity of the enamel paste possibly being observed by increasing and/or maintaining the yield stresses for the time required to reduce the viscosity.

Given that the rounded fillers made of a material having a melting point greater than 900° C. and MOHS hardness less than 6 are denser than glass beads, the use of thixotropic rheofluidifying pastes makes it possible to obtain a uniform distribution thereof on the surface of the enamel coating. In fact, at rest, the beads, in spite of their high density, are maintained in suspension in the paste and the sedimentation of the fillers in the paste is slowed down significantly, or even stopped, which makes it possible to apply a coating layer containing a constant percentage of beads in the deposition at any time. Moreover, in order to facilitate the spreading of the enamel paste, its viscosity must be minimal during procedures such as the transfer of the paste or the application thereof onto a substrate, for example to facilitate the flow thereof through the meshwork of a serigraphic screen.

Therefore, the present invention relates to a cooking utensil comprising a base with an inner face capable of receiving foods and an outer face intended to be arranged on the side of a heat source, the outer face being coated with an enamel coating, which comprises rounded fillers protruding such that the protrusion is visible.

The rounded fillers are made of a material having a melting point greater than 900° C. and MOHS hardness less than 6, and those protruding are distributed homogeneously on the surface of said coating.

Preferentially, the surface density of the fillers protruding from the surface of the enamel coating is between 150 and 300 beads per mm².

Over a visible filler surface density of 300 beads per mm², a decrease in the thermal and mechanical shock resistance and a loss of luster are observed.

Below a visible filler surface density of 150 beads per mm², the weight distribution of the object is not sufficiently uniform and a susceptibility to scratching the vitroceramic or induction hob is observed.

Preferentially, the rounded fillers are made of a material wherein the MOHS hardness is less than or equal to 5.5.

Examples of rounded fillers or beads that can be used in the cooking utensil according to the invention include metal beads and alloys, particularly copper, bronze and heat-resistant steel beads.

Preferentially, stainless steel beads are used. In fact, such beads offer the advantage of being subject to little or no oxidation at the enamel firing temperature.

The visible rounded metal fillers make it possible both to increase the wear resistance of the enamel coating and to reduce the friction coefficient thereof due to the decrease in the contact surface area between the utensil (via its beads) and the hob and the lower hardness of the metal beads, such that this coating is easy to clean and does not represent any risk of scratching sensitive surfaces, such as vitroceramic or induction hobs.

Advantageously, the enamel coating comprises at least one outer layer which is a serigraphic layer obtained from a thixotropic rheofluidifying enamel paste, the outer layer containing rounded fillers.

The term “outer serigraphic layer” refers to an enamel layer obtained by applying a 15 to 30 μm layer of thixotropic rheofluidifying enamel paste by means of serigraphy.

According to a first embodiment of the present invention, the enamel coating successively comprises, from the base of the utensil:
a first enamel layer, referred to as the adherence layer, covering the outer face of the base,
a second enamel layer, referred to as the covering layer, covering the adherence layer, and
a third enamel layer containing the rounded fillers and forming an outer serigraphic layer completely covering the covering layer.

According to a second embodiment of the present invention, the enamel coating also comprises a fourth enamel layer containing rounded fillers according to the invention and forming a decoration partially covering the third enamel layer, such that some of the fillers in the fourth enamel layer are resting on those of the third enamel layer.

The rounded fillers according to the invention, particularly metal beads, are anchored solidly in the enamel of the serigraphic layers in spite of the smooth surface thereof, which is not favorable for the anchorage thereof in enamel layers. However, as serigraphy is a technique consisting of applying an enamel paste (anhydrous enamel frit powder-based paste) through the meshwork of a screen, by means of a scraper, such a technique will result in the deposition of a layer of a uniform thickness guaranteed by the serigraphic screen wire diameter and good bead distribution in the enamel layers.

More specifically with respect to the second embodiment of the invention, the subsidence of the beads in the fourth enamel layer (second serigraphic layer) is controlled, firstly, by the presence of beads in the underlying third enamel layer (first serigraphic layer) whereon at least some of the beads of the fourth enamel layer can rest. Secondly, the beads present in the third enamel layer make it possible to increase the wear resistance and facilitate the cleaning of the parts of this layer which are not coated with the discontinuous enamel decorative layer.

The cooking utensil according to the invention comprises a cast iron or enamellable steel bowl, comprising the enameled base as described above.

Examples of enamellable steels that can be used according to the invention to produce the bowl particularly include low-carbon steels and decarburized steels. In one particular embodiment, the bowl is made of cast iron.

The composition of the enamel can be adjusted to the type of substrate.

The maximum bead diameter is at least equal to twice the thickness of the outer enamel layer. In this way, all the beads are inserted in a serigraphic enamel layer according to a depth which is at least equal to their diameter, which can allow excellent anchorage of the beads in the enamel layer.

The diameter of the beads is between about 5 and 40 microns, the mean diameter of these beads being between about 15 and 20 microns, and the thickness of the outer enamel layer is between about 15 and 30 microns.

In one embodiment, the outer enamel layer contains between about 5 and 30% beads by weight.

Below 5% beads, the effect thereof on the properties of the enamel becomes negligible, whereas, over 30%, the cohesion between the beads and the enamel is impaired.

The outer enamel layer can also comprise solid lamellar structured particles having lubricant properties such as talc, graphite, molybdenum disulphide, vanadium disulphide, boron nitride and mixtures thereof.

These lamellar structured particles play the role of lubricant particles which reduce the friction coefficient of the enamel coating significantly and thus decrease the abrasive effect of the bob on the utensil considerably. In addition, these lamellar structured particles give the enamel layer easy cleaning properties. The lamellar structured particles can be contained in the fourth enamel layer, as they complete the action of the beads, or even take over from same when they are worn to the surface of the layer.

The present invention also relates to a non-fired intermediate part resulting, after firing, in a cooking utensil according to the invention, wherein the non-fired enamel coating comprises an outer layer of thixotropic rheofluidifying enamel paste and the rounded fillers are made of a material having a melting point greater than 900° C. and MOHS hardness less than 6, the fillers protruding from the enamel coating being distributed homogenously in the outer layer of enamel paste.

In one embodiment, the layer of thixotropic anhydrous paste comprises about 5 to 30% rounded fillers by weight.

Finally, the present invention also relates to a method to manufacture a cooking utensil according to the invention which comprises:
application on the outer face of the base of a first enamel layer, referred to as the adherence layer, by spraying an aqueous enamel frit suspension, followed by drying and firing at a temperature greater than 800° C.;
application on the fired adherence layer, of a second enamel layer, referred to as the covering layer, also by spraying an aqueous enamel frit suspension followed by drying, the covering layer forming, after drying, the bisque;
serigraphic application, on the covering layer, of a layer of enamel paste containing rounded filters, followed by drying, said first anhydrous paste layer being intended to form after firing the first enamel layer, or first serigraphic enamel layer; and
firing, for example, at a temperature between 770 and 820° C.

According to the invention, the spherical fillers used are made of a material having a melting point greater than 900° C. and MOHS hardness less than 6, and the enamel paste is rheofluidifying and thixotropic.

According to an embodiment of the method according to the invention, said method also comprises, between the serigraphic application and the final firing step, a serigraphic application step on the continuous dried enamel paste layer, of a discontinuous rheofluidifying and thixotropic enamel paste, containing rounded fillers, followed by drying.

The layer(s) of enamel paste form(s), once dried (particularly by means of infrared or using radiant tubes), the bisque. In order to increase the hardness of the bisque and decrease the porosity thereof, cohesive agents are incorporated therein in order to render it more cohesive and less porous.

Examples of the cohesive agents that can be used in the enamel layers according to the invention particularly include organic binders, gums and carboxymethylcellulose (CMC). These cohesive agents disappear during the firing of the bisque.

Finally, an anti-adhesive layer (made of PTFE or enamel) can be applied on the inner face of the base of the bowl.

### BRIEF DESCRIPTION OF THE DRAWINGS

Other advantages and specificities of the present invention will emerge from the description below, given as a non-limitative example and with reference to the appended figures:

FIG. 1 is a schematic sectional view of a cooking utensil according to the invention according to a first alternative embodiment; and

FIG. 2 is a schematic sectional view of a cooking utensil substrate according to the invention according to an alternative embodiment.

### DETAILED DESCRIPTION

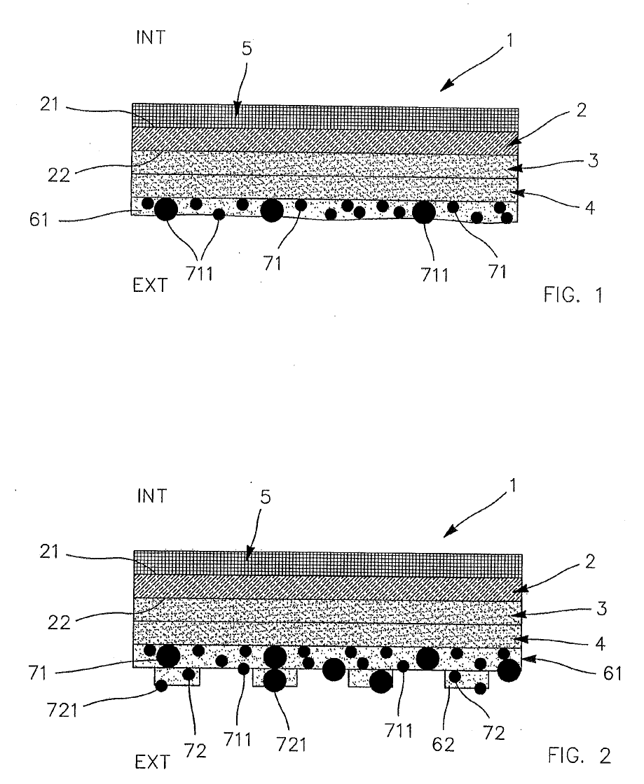

Referring to FIG. 1, a cast iron cooking utensil 1 comprises a hollow bowl defining a base 2, wherein the outer face 22 is coated with a first enamel layer 3 (or adherence layer), which is in turn coated with a second enamel layer 4 (or covering layer). This covering layer 4 is in turn coated with a continuous serigraphic enamel layer 61 comprising metal spherical fillers 71, 711, some 711 of which protrude from the surface of said layer 61.

In an alternative embodiment depicted in FIG. 2, a discontinuous serigraphic enamel layer 62 forming the decoration partially covers the serigraphic layer 61. This enamel layer 62 also comprises metal spherical fillers 72, 721, part 721 of which protrudes from the surface of said layer. Part of the fillers 711 of the underlying serigraphic layer 61 protrudes from the surface of the parts of the layer 61 which are not coated with the decorative layer 62.

FIGS. 1 and 2 also depict the inner surface 21 of the base 2 as coated with an anti-adhesive layer 5.

The adherence layer 3 and, if applicable, the covering layer 4, can cover the entire outer face of the bowl of the utensil 1 (not shown in the figures), while the serigraphic enamel layers 61, 62 are only applied in the area of the base 2 of the utensil 1.

The adherence 3 and covering 4 layers are applied by spraying using an aqueous enamel frit suspension, while the two serigraphic enamel layers 61, 62 containing the metal beads 71, 711, 72, 721 are obtained by means of application, followed by drying, of rheofluidifying and thixotropic enamel pastes, the pastes possibly being sintered at a temperature of the order of 770° to 820° C.

During the serigraphic application of the enamel pastes to form serigraphic enamel layers 61, 62, they are pushed through the meshwork of a screen by means of a scraper which deposits the beads 71, 711, 72, 721 in their respective enamel layer 61, 62. In this way, the beads 71, 711 of the third enamel layer 61 (or first serigraphic layer) rest on the surface of the underlying enamel layer which is the covering layer 4, while the beads 72, 721 of the fourth enamel layer 62 (or second serigraphic layer) rest on the beads 71, 711 of the third enamel layer.

The enamel layers 3, 4, 61, and, if applicable, the layer 62, are fired simultaneously at a temperature of the order of 770° C.-820° C.

Each serigraphic enamel layer 61, 62 contains between 5 and 30% of spherical fillers 71, 711, 72, 721 by weight.

With respect more specifically to an alternative embodiment of the invention, during the application of the fourth enamel layer 62, the beads 72, 721 thereof cannot subside in the third enamel layer 61 as the beads 71, 711 contained therein 61 limit the subsidence of the beads 72, 721. The beads 72, 721 of the second serigraphic layer 62 enable same to resist wear, while retaining the aesthetic appearance of the raised relief decoration formed by said layer 62. The beads 71, 711, besides the properties described above, protect the parts of the enamel layer 61 which are not coated with the discontinuous layer 2 against wear, while facilitating the cleaning of these parts.

The serigraphic enamel layer(s) 61, 62 may, between the metal beads 71, 711, 72, 721, also contain lamellar structured solid particles having lubricant properties such as talc, graphite, molybdenum disulphide, vanadium disulphide, boron nitride, etc. and mixtures thereof. These lubricant particles facilitate the application of serigraphic enamel layers 61, 62 and increase the easy cleaning properties thereof.

A method of making an embodiment of an enameled cooking utensil according to the alternative embodiment of the invention, including:
spraying on the outer face of the bowl of the utensil of an enamel frit suspension, to form an enamel adherence layer 3, followed by drying and firing at a temperature greater than or equal to 800° C.;
spraying on the fired adherence layer 3 of an enamel frit suspension to form the enamel covering layer 4;
after drying of the covering layer 4, a layer 61 of thixotropic rheofluidifying enamel paste containing metal beads 71, 711 is applied thereon, by means of serigraphy; and
after drying of the paste layer 61, a discontinuous layer 62 of thixotropic rheofluidifying enamel paste containing metal beads 72, 721, intended to form a decoration after firing, is applied thereon, also by means of serigraphy.

The composition of each of the anhydrous enamel frit paste layers 61, 62 is specified below:

(a) 30 to 50% by weight of an enamel frit powder with respect to the total weight of the paste, the enamel frit comprising:

SiO₂: 35-65%

B₂O₃: 10-25%

Na₂O: 5-20%

TiO₂: 5-20%

K₂O: <10%

ZnO: <5%

NO₂: <5%

P₂O₅: <2%

ZrO₂: <2%

LiO₂: <1%

MgO: <1%

(b) 5 to 30% by weight of mineral pigments with respect to the total weight of the paste, and

(c) 5 to 30% by weight with respect to the total weight of the paste of metal beads having a diameter between 5 and 40 microns, with a mean diameter between 15 and 20 microns, according to the density of said fillers.

(d) 20 to 50% by weight with respect to the total weight of the paste of a formulation based on resin derivative (such as pine oil) or terpene derivatives (such as a mixture of terpene alcohols such as that marketed under the brand Terpineol by DRT located in Dax (40105, France) comprising:
20 to 50% by weight of resins or terpene derivatives,
30 to 50% by weight of dearomatised kerosene,
5 to 20% by weight of ethylcellulose, and
1 to 10% by weight of wax.

The wax essentially provides the serigraphic pastes with thixotropy.

Without any mechanical stress, the wax is solidified and renders the enamel paste containing the same highly viscous and thus makes it possible to keep the metal spherical fillers in suspension in this paste. Then, under the effect of a mechanical stress, particularly by shearing, and in particular that applied by a scraper during a serigraphic application process, the wax is no longer solidified and the enamel paste containing the metal beads becomes liquid, which facilitates the spreading thereof on the surface of the cooking utensil.

After the serigraphic application of the layer of enamel paste, the wax contained in these layers is again solidified rapidly and makes it possible to keep the spherical fillers in suspension throughout the thickness of the paste.

After firing, a cooking utensil wherein the outer face of the base comprises an enamel coating with a surface density of 150 to 300 beads/mm² on the surface of the coating is obtained.

1. A non-scratch enameled cooking utensil comprising a base, the base presenting an inner face adapted to receive food, and an outer face adapted to be positioned proximate a heat source, said outer face being at least partially coated with an enamel coating, the enamel coating comprising a plurality of rounded fillers, wherein at least some of the plurality of rounded fillers protrude from said enamel coating such that said protruding rounded fillers are visible from an outer surface of the enamel coating, and wherein said rounded fillers are formed from a material having a melting point greater than about 900 degrees Celsius and having a MOHS hardness less than 6, and wherein said protruding rounded fillers are distributed homogeneously on the outer surface of said enamel coating.

2. The non-scratch enameled cooking utensil according to claim 1, wherein a surface density of the protruding rounded fillers is between about 150 and 300 fillers per square millimeter.

3. The non-scratch enameled cooking utensil according to claim 1, wherein the MOHS hardness of the material of said rounded fillers is less than or equal to 5.5.

4. The non-scratch enameled cooking utensil according to claim 1, wherein the material of said rounded fillers comprises metal.

5. The non-scratch enameled cooking utensil according to claim 1, wherein the enamel coating comprises at least one serigraphic layer formed from a thixotropic rheofluidifying enamel paste, said at least one serigraphic outer layer including the plurality of rounded fillers.

6. The non-scratch enameled cooking utensil according to claim 5, wherein said enamel coating further comprises:
a first enamel layer, covering at least a portion of the outer face of the base; and
a second enamel layer covering at least a portion of said first enamel layer,
wherein the at least one serigraphic layer comprises a third continuous enamel layer substantially covering an entirety of said second enamel layer.

7. The non-scratch enameled cooking utensil according to claim 6, wherein the at least one serigraphic layer further comprises a fourth enamel layer partially covering said third enamel layer, said fourth enamel layer including a plurality of rounded fillers and forming a discontinuous outer layer defining a decoration.

8. The non-scratch enameled cooking utensil according to claim 1, wherein the cooking utensil comprises a cast iron bowl or enamellable steel bowl.

9. The non-scratch enameled cooking utensil according to claim 5, wherein at least some of the plurality of rounded fillers are spherical in shape, each spherical rounded filler having a diameter equal to or less than about twice a thickness of the at least one serigraphic layer.

10. The non-scratch enameled cooking utensil according to claim 9, wherein the diameter of each spherical rounded fillers is between about five and forty micrometers, and the thickness of the at least one outer serigraphic layer being between about fifteen and thirty micrometers.

11. The non-scratch enameled cooking utensil according to claim 5, wherein the at least one serigraphic layer comprises between about five and thirty percent by weight of metal fillers.

12. A non-fired intermediate cooking utensil adapted to form, upon firing, the non-scratch enameled cooking utensil according to claim 1, the non-fired intermediate cooking utensil comprising an unfired enamel coating, wherein the unfired enamel coating comprises at least one layer of thixotropic rheofluidifying enamel paste including said rounded fillers.

13. The intermediate product according to claim 12, wherein said layer of thixotropic rheofluidifying enamel paste comprises about five to thirty percent by weight of rounded fillers.

14. A method to manufacturing a non-scratch enameled cooking utensil, the method comprising:
providing a cooking utensil comprising a base presenting an inner face adapted to receive food, and an outer face adapted to be positioned proximate a heat source;
spraying a first aqueous enamel frit suspension on the outer face of the base, forming a first enamel layer;
drying and firing the first enamel layer at a temperature greater than about 800° C.;
spraying a second aqueous enamel frit suspension over at least a portion of said first enamel layer, forming a second enamel layer;
drying and firing the second enamel layer;
serigraphing a continuous enamel paste layer over at least a portion of the second enamel layer, forming a third enamel layer;
drying the third enamel layer; and
firing of the cooking utensil to form the non-scratch enameled cooking utensil,
wherein the continuous enamel paste layer comprises a plurality of rounded fillers formed from a material having a melting point greater than 900° C. and a MOHS hardness less than 6, and wherein the continuous enamel paste layer is rheofluidifying and thixotropic.

15. The method according to claim 14, wherein the continuous enamel paste layer comprises from about five to about thirty percent by weight of rounded fillers.

16. The method according to claim 14, the continuous enamel paste layer further comprises from about one to ten percent by weight of wax, and about twenty to fifty percent by weight of resin or terpene derivatives.

17. The method according to claim 14, further comprising, between drying of the third enamel layer and firing of the cooking utensil:
applying, by serigraphy, a discontinuous enamel paste layer over at least a portion of the third enamel layer, forming a fourth enamel layer; and
drying the fourth enamel layer,
wherein the discontinuous enamel paste layer comprises a plurality of rounded fillers formed from a material having a melting point greater than 900° C. and a MOHS hardness less than 6, and wherein the discontinuous enamel paste layer is rheofluidifying and thixotropic.

18. The method according to claim 14, wherein the second aqueous enamel frit suspension used to form the second enamel layer comprises cohesive agents.

19. The method according to claim 18, wherein the cohesive agents comprises organic binders, gums, or carboxymethylcellulose.
